(19) United States
(12) Patent Application Publication
(10) Pub. No.: US 2006/0017303 A1
(43) Pub. Date: Jan. 26, 2006

(54) Collapsible soft top cover and overhead rack sytem for a pickup truck

(76) Inventors: Michael E. Weege, Evergreen, CO (US); Dorothy N. Kohn, Longmont, CO (US)

Correspondence Address: W. Scott Carson, Esq.;Dorr, Carson, Sloan, Birney & Kramer, P.C., 3010 East 6th Avenue, Denver, CO, 80206, US

(21) Appl. No.: 10/894,816

(22) Filed: Jul. 20, 2004

(51) Int. Cl. B60P 7/02

(52) U.S. Cl. 296/105

(57) ABSTRACT

Apparatus including a collapsible soft top and frame arrangement for the bed of a pickup truck or similar vehicle. The frame arrangement includes a plurality of support or bow members for the soft top and additionally has overhead rack members to carry loads such as ladders, pipes, lumber, and gear trays. In use, the soft top and frame arrangement can be quickly and easily collapsed as a unit to uncover the bed of the pickup truck. Conversely, it can just as quickly and easily be extended to cover the bed and to carry loads on the overhead rack members.

### BACKGROUND OF THE INVENTION

1. Field of the Invention

This invention relates to the field of soft top covers and overhead rack systems for pickup trucks.

2. Discussion of the Background

Soft top covers for pickup trucks are very popular to protect the bed and its contents from exposure to the elements and to provide a level of security. Equally popular are overhead racks for pickup beds to support camping, hunting, and other gear for recreation as well as commercial equipment such as ladders, pipes, lumber, and other loads. Such loads are often relatively heavy on the order of several hundred pounds or more. Presently, very few combinations of collapsible soft tops and supporting frame arrangements with overhead racks are available and in all known ones, their designs and operations are fairly complicated and difficult to use.

With this and other problems in mind, the present invention was developed. In it, a collapsible soft top is provided with a frame arrangement that not only supports the soft top but also supports overhead rack members wherein the soft top and frame arrangement including the overhead rack members can be easily and quickly folded or collapsed as a unit.

### SUMMARY OF THE INVENTION

This invention involves an apparatus including a collapsible soft top and frame arrangement for the bed of a pickup truck or similar vehicle. The frame arrangement includes a plurality of support or bow members for the soft top and additionally has overhead rack members to carry loads such as ladders, pipes, lumber, and gear trays. The frame arrangement is designed to carry relatively heavy loads (e.g., 300-350 pounds) and can include angle pieces for additional strength and stability. In use, the soft top and frame arrangement can be quickly and easily collapsed as a unit to uncover the bed of the pickup truck. Conversely, it can just as quickly and easily be extended to cover the bed and to carry loads on the overhead rack members.

The front and rear portions of the soft top include securing arrangements to extend respectively across the vehicle tailgate and front wall in sealing engagements. The frame arrangement also includes an additional bow member to incrementally adjust the tension in the fabric of the soft top as needed and desired to maintain a tight fit on the frame arrangement. The soft top further includes side panels and specially designed attachments for the upper edge portion of each side panel. The upper attachments have at least two, substantially rigid retainers that can pivot relative to each other as the soft top is folded or collapsed.

### BRIEF DESCRIPTION OF THE DRAWINGS

FIG. 1 is a perspective view, of the soft top and frame arrangement of the present invention in an extended position covering the bed of the pickup truck with various loads supported on the overhead rack members of the frame arrangement.

FIG. 2 is a view similar to FIG. 1 with the loads removed from the overhead rack members.

FIG. 3 illustrates the soft top and frame arrangement of the present invention in a collapsed position uncovering the bed of the pickup truck.

FIG. 4 is a view similar to FIG. 3 with the soft top removed for clarity showing the frame arrangement of the present invention.

FIG. 5 is a cross-sectional view taken along line 5-5 of FIGS. 2 and 6.

FIG. 6 is a cross-sectional view taken along line 6-6 of FIG. 2

FIG. 7 is an enlarged cross-sectional view of the circled area of FIG. 5. It is also a view taken along line 7-7 of FIG. 6.

FIG. 8 is an exploded view of the frame arrangement of the present invention.

FIG. 9 illustrates a portion of the front support or bow member and the removable angle piece that may be included for additional support and stability.

FIG. 9(a) is a view taken along line 9(a)-9(a) of FIG. 9.

FIG. 10 is a view of one side of the rear support or bow member and the overhead rack member and tensioning member mounted on it.

FIG. 11 is a view taken along line 11-11 of FIG. 9.

FIG. 12 is a view taken along line 12-12 of FIG. 9.

FIG. 13 is an enlarged cross-sectional view of the circled area of FIG. 6 illustrating the manner in which the front edge portion of the soft top is removably secured in place over the front wall of the pickup truck.

FIG. 14 is an enlarged cross-sectional view of the circled area of FIG. 6 illustrating the manner in which the rear edge portion of the soft top is removably secured in place over the tailgate of the pickup truck.

FIG. 15 illustrates the manner in which the tension in the fabric of the soft top can be selectively adjusted.

FIG. 16 is a sequential view of how the legs of the tension member for the soft top can be incrementally lengthened to adjust the tension in the soft top.

FIG. 17 is a side elevational view of the soft top and one of the removal window panels in it.

FIG. 18 is a view taken along line 18-18 of FIG. 17.

FIG. 19 is a view of the partially collapsed soft top and frame arrangement with the side panel removed.

### DETAILED DESCRIPTION OF THE INVENTION

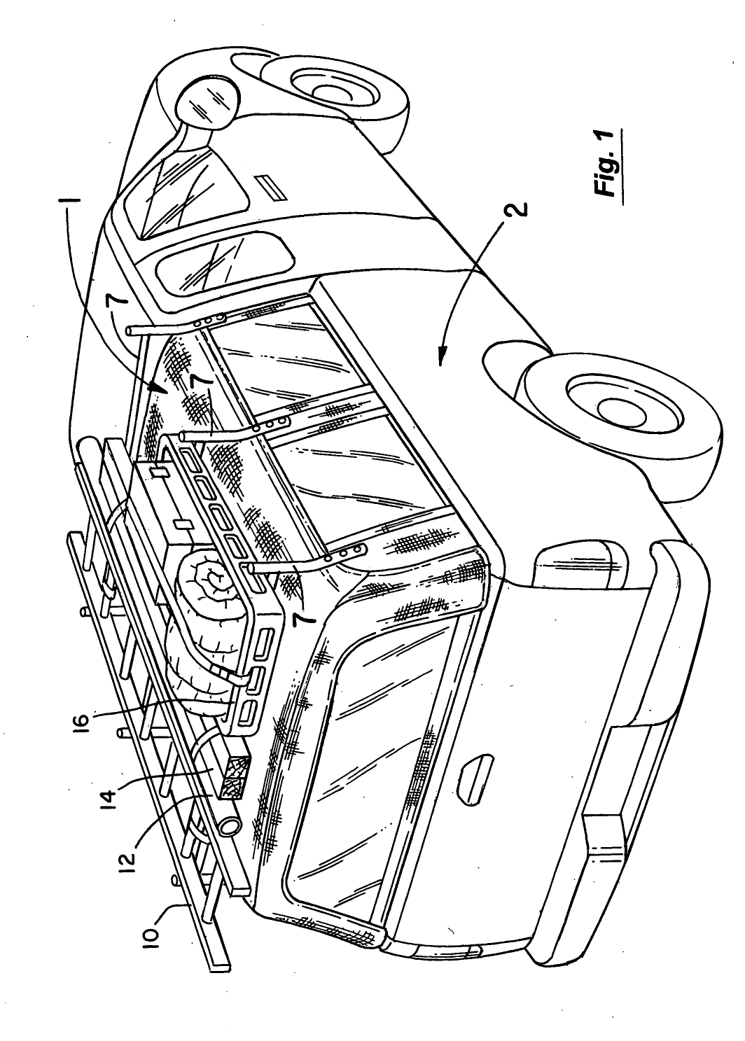

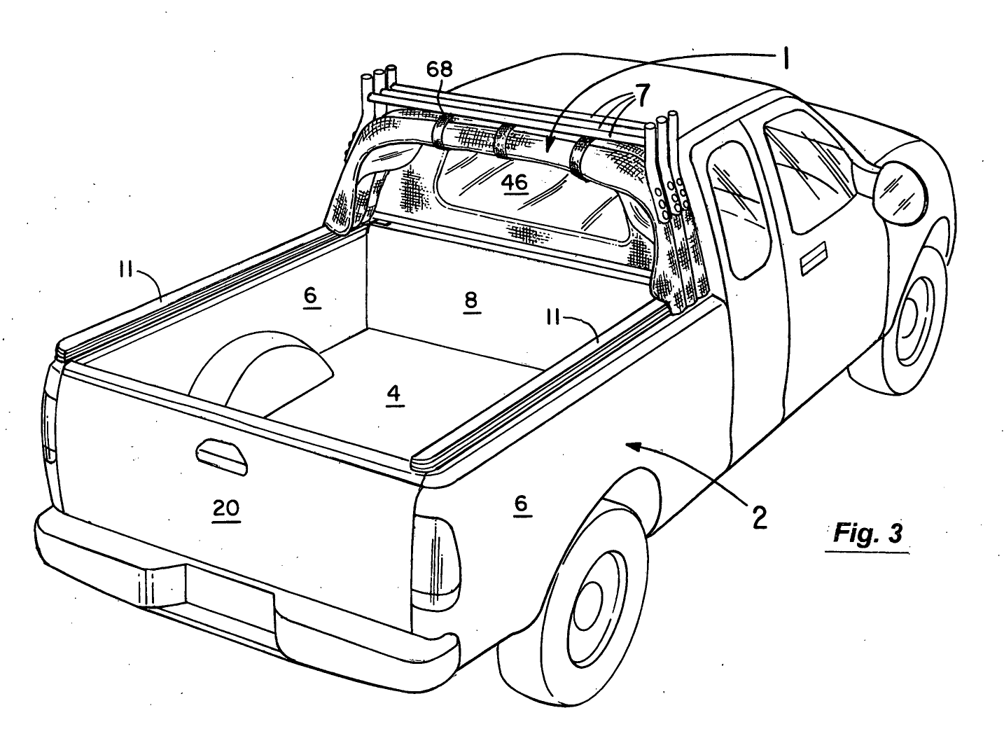

As best seen in FIGS. 1-3, the apparatus of the present invention includes a collapsible soft top 1 for a pickup truck or similar vehicle 2. The pickup truck 2 as shown in FIG. 3 has a rear bed 4 with spaced-apart side walls 6 and a front wall 8 which extend upwardly from the bed 4. The soft top 1 in turn is mounted on a collapsible frame 3 (see FIG. 4) that includes the illustrated, three support or bow members 5 and overhead rack members 7.

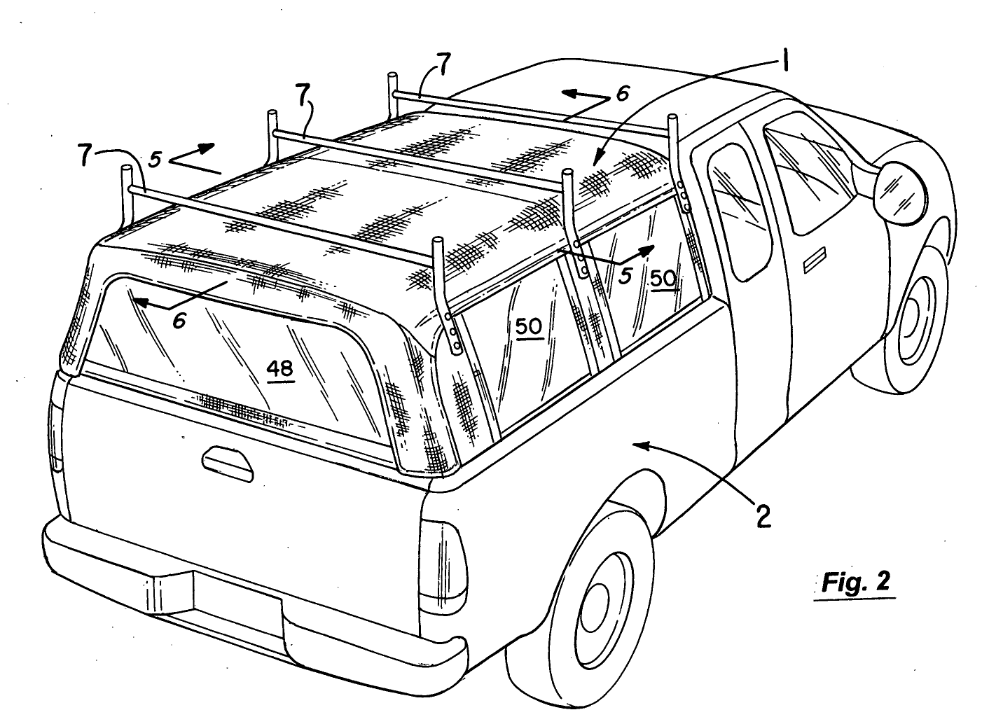

In use as shown in FIGS. 1-3, the apparatus of the soft top 1 and frame arrangement 3 can be moved from a collapsed position substantially uncovering the pickup truck bed 4 (FIG. 3) to an extended position (FIG. 2) covering the bed 4. In the extended position of FIG. 2, loads such as the illustrated ladder 10, pipe 12, lumber 14, and gear tray 16 of FIG. 1 can then be carried on the overhead rack members 7. In particular, the frame arrangement 3 of the present invention is specifically designed to be able to carry fairly heavy loads (e.g., 300-350 pounds) as in FIG. 1. However, the frame arrangement 3 is still capable of being easily and quickly collapsed (FIG. 3) without having to remove the soft top 1. Conversely, the collapsed soft top 1 and frame arrangement 3 of FIG. 3 can be equally as quickly and easily extended to again cover the pickup bed 4 and position the rack members 7 to carry the overhead loads such as 10, 12, 14, and 16 of FIG. 1.

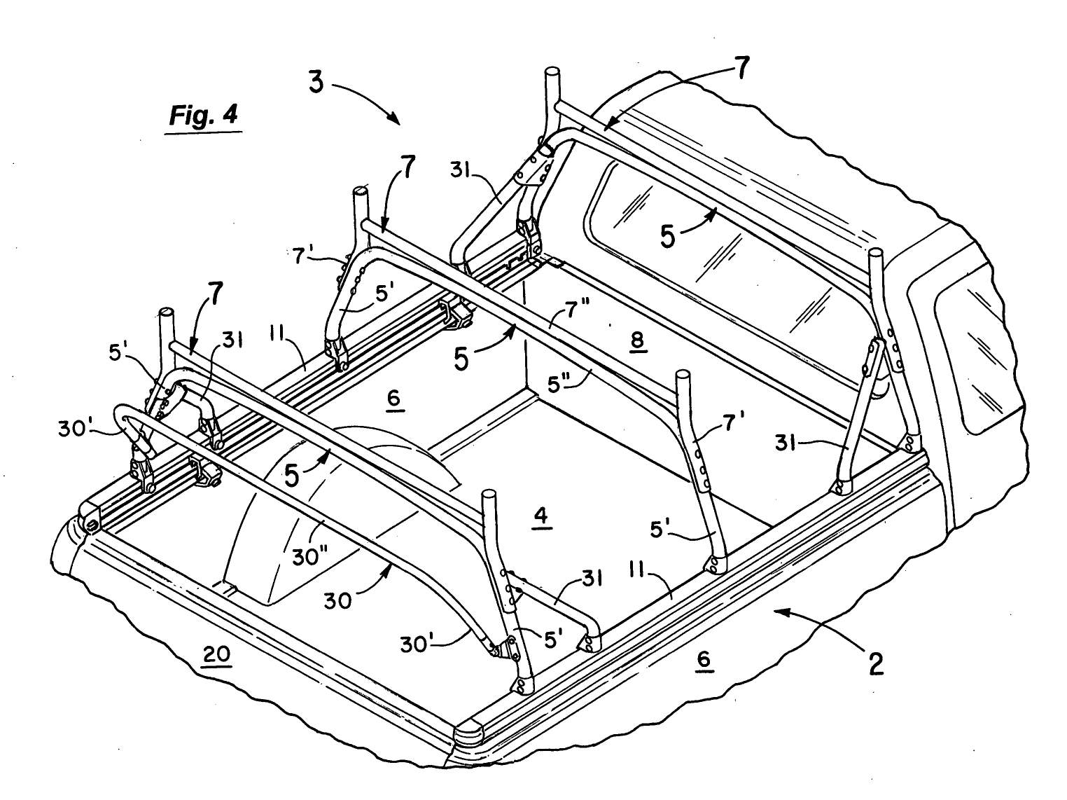

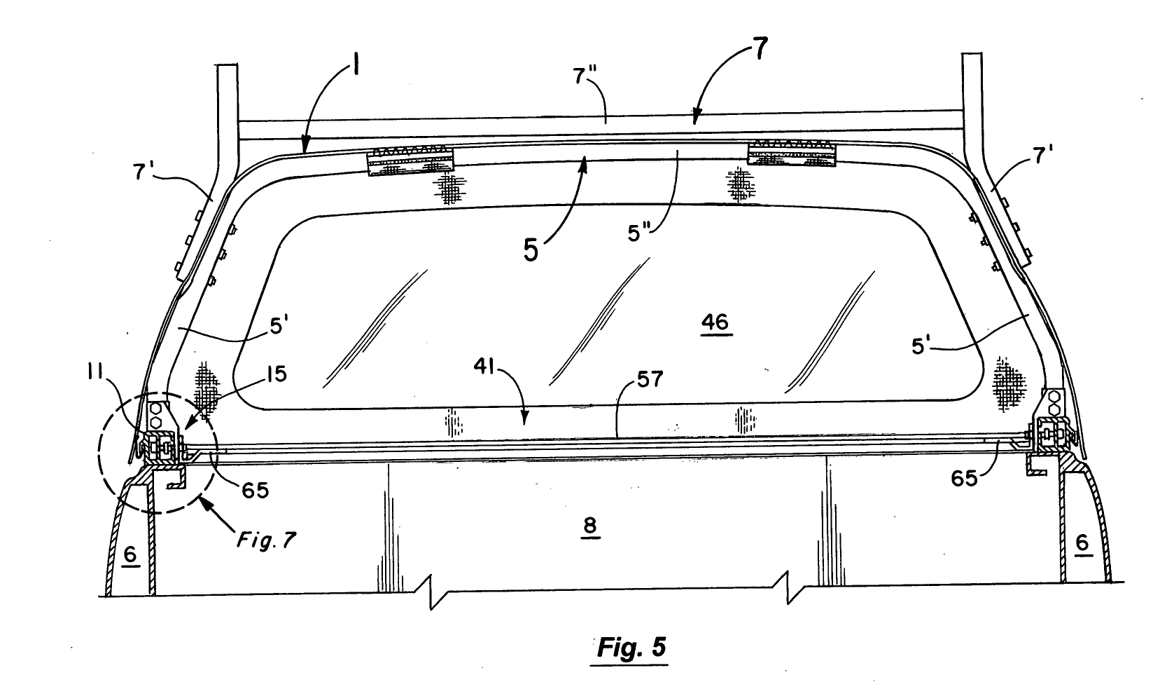

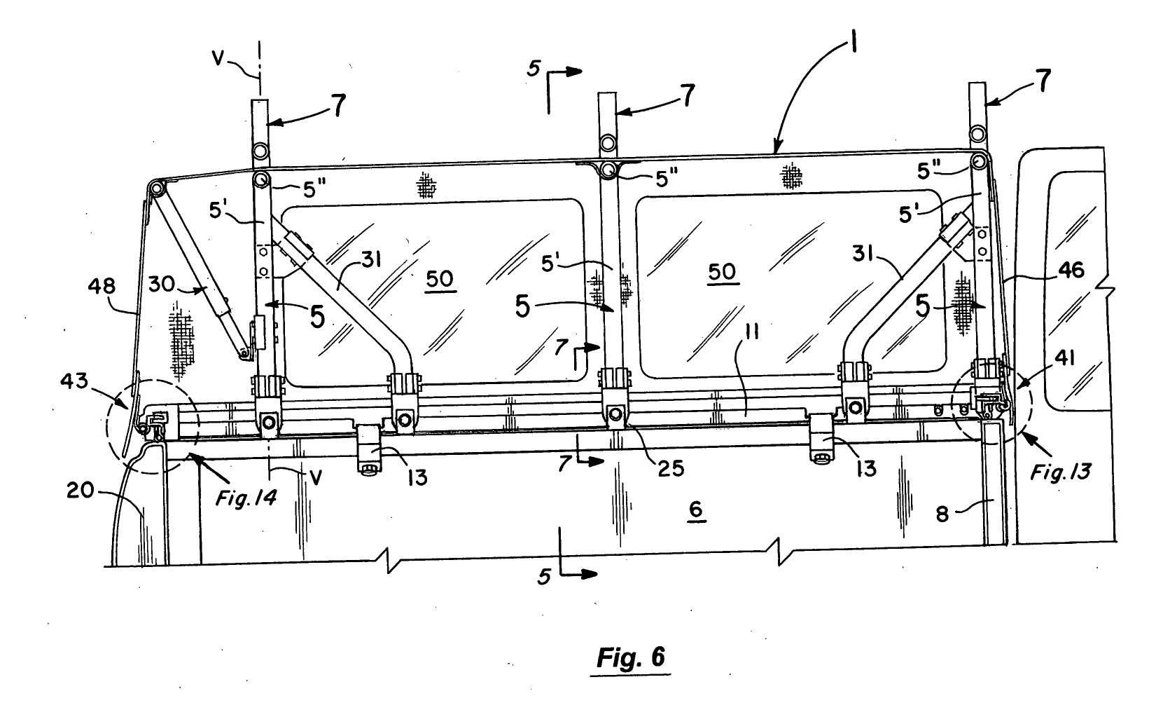

More specifically, the frame arrangement 3 (which is shown for clarity without the soft top 1 in FIG. 4 and then with the soft top 1 in FIGS. 5 and 6) includes a plurality of support or bow members 5 and overhead rack members 7. Each support member 5 as illustrated in FIG. 5 has an inverted, substantially U-shape with spaced-apart legs 5′ and a base 5″ extending therebetween. The soft top 1 in turn is positioned on the support members 5 over the bases 5″ (FIGS. 5 and 6). The soft top 1 then extends not only laterally between the pickup side walls 6 and across the bed 4 (FIG. 5) but also front-to-back or lengthwise between the support members 5 (FIG. 6).

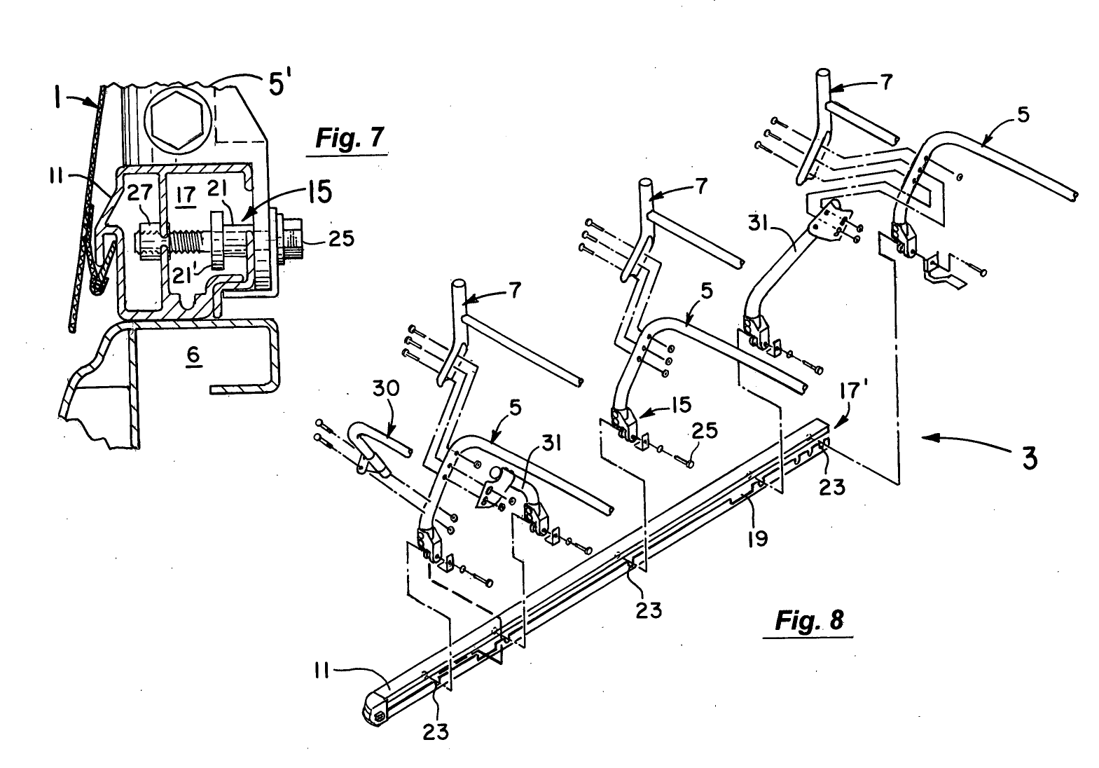

Each support leg 5′ as shown in FIG. 7 (which is a view taken from the circled area of FIG. 5 and along line 7-7 of FIG. 6) is mounted on a respective side wall 6 of the pickup truck 2. This can be done directly but in the illustrated embodiment of FIGS. 5-7, this mounting is accomplished using a rail 11. The rails 11 can be removably attached in any number of manners to the side walls 6 including by the illustrated clamps 13 of FIG. 6. With the rails 11 attached to the side walls 6 or even before being attached, the protruding members 15 on each end of the support legs 5′ can be positioned as in FIG. 7 in the channel 17 of the rail 11. The protruding members 15 in this regard can either be slid into the open front end 17′ of the channel 17 (FIG. 8) or moved laterally in FIG. 8 through one of the enlarged cut-outs 19. Regardless and once received in the channel 17, the stem 21 (FIG. 7) of each protruding member 15 is then slid along the channel 17 until received in a predetermined position in a notch such as 23 (FIG. 8) in the side piece of the channel 17. A bolt 25 or similar device (see again FIG. 7) can be subsequently passed through the hollow stem 21 of the protruding member 15 and tightened into the stationary nut 27 in an opposing side piece of the channel 17. In this manner, each leg 5′ of the support members 5 is securely held in place atop the rail 11 and side wall 6.

Each support member 5 and particularly the front and rear support members 5 as illustrated in FIGS. 4 and 6 can optionally have angle pieces 31 if desired for additional support and integrity. That is, each overhead rack member 7 and the underlying support member 5 are preferably aligned substantially in a common vertical plane (e.g., V-V in FIG. 6). Consequently, there is little if any torque from the weight of the static loads on the rack members 7 tending to rotate the underlying support members 5 forwardly or rearwardly (e.g., about a horizontal axis in the vertical plane V-V). Nevertheless, the angle pieces 31 can be added if desired to further increase the stability of the loaded support members 5, particularly to limit front-to-back movement or sway of the support members 5 during acceleration and deceleration of the pickup truck 2. Preferably, the pieces 31 extend generally at an acute angle (e.g., 45 degrees to the vertical plane V-V in FIG. 6) substantially between the support leg 5′ and the side wall 6.

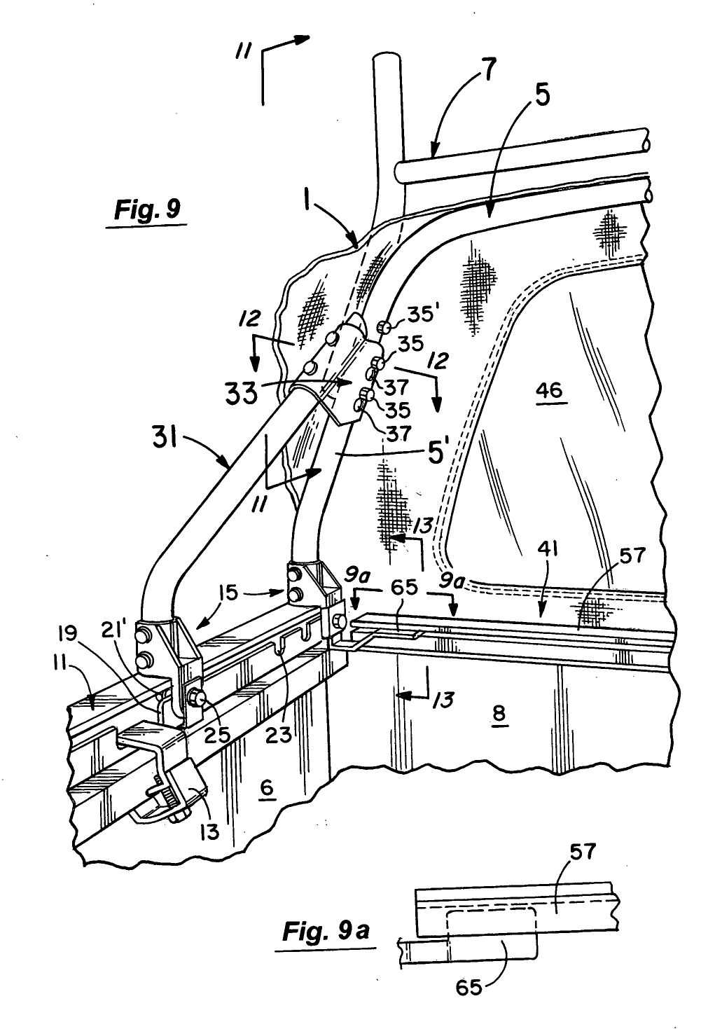

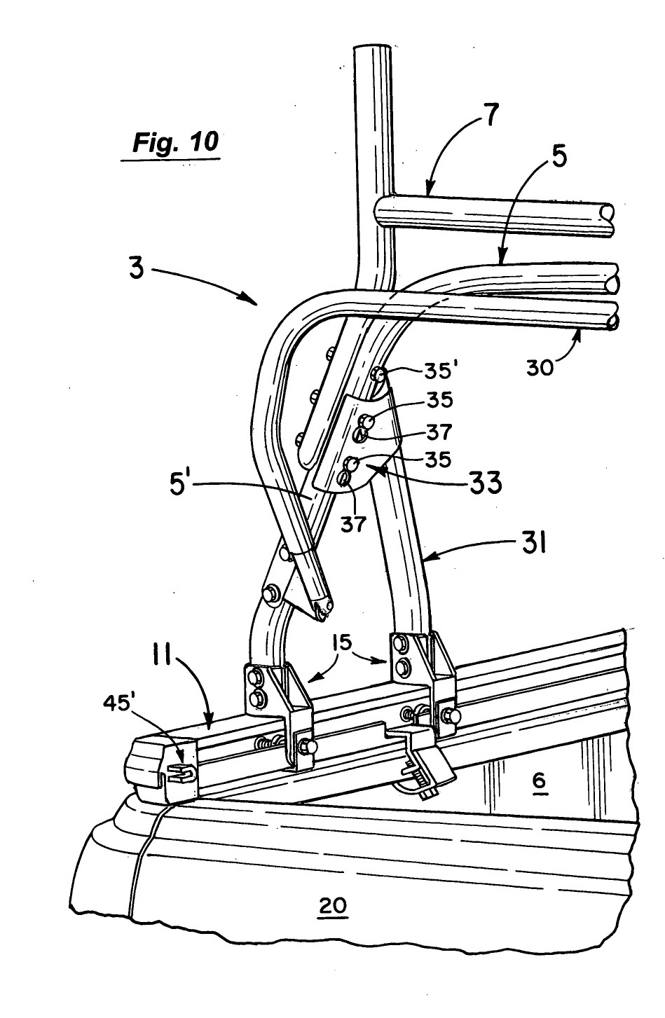

The optional angle pieces 31 are further illustrated in FIGS. 9 and 10. As shown, each piece 31 has a lower end like the end of each support member 5 in FIG. 7 with a protruding member 15. As in FIG. 7, each protruding member of the angle piece 31 can be received and bolted in a predetermined notch like 23 in rail 11. Additionally, the upper end of each angle piece 31 has a flange 33 (FIG. 9) that can be releasably attached to the leg 5′ of the support member 5. The attaching arrangement is specially designed so that the angle piece 31 can be detached from the support member 5 without having to remove the soft top 1. In doing so, the bolt 25 of the lower end of each angle piece 31 (see again FIG. 9) is removed and the two bolts 35 at the upper end of the angle piece 31 are loosened. The angle piece 31 can then be manually manipulated to align the enlarged, lower holes 37 in the flange 33 with the smaller nuts on the bolts 35. The flange 33 and upper end of the angle piece 31 can subsequently be removed from engagement with the bolts 35 and the lower end of the angle piece 31 slid along the channel 17 in rail 11 to an enlarged cutout 19 (FIG. 9) and removed. Alternatively, the protruding member 15 of the angle piece 31 in FIG. 9 could be made without the head 21′ on the stem 21 (see also FIG. 7). In this manner, once the bolt 25 of the protruding member 15 in FIG. 9 is removed and the two bolts 35 loosened, the angle piece 31 can be simply moved laterally to remove its stem 21 from the rail channel 17 (versus sliding the stem 21 along the channel 17 to the enlarged notch 19).

With the angle pieces 31 so removed, the frame arrangement 3 can be easily and quickly collapsed to the position of FIG. 3 without having to remove the soft top 1. The soft top 1 and frame arrangement 3 can thus be moved as desired from the extended position of FIGS. 2 and 6 to the collapsed position of FIG. 3. In the collapsed position, the legs 5′ of the three bow members 5 are preferably in predetermined locations with the respective stem members 21 in the front three notches 23 in the rails 11. In the extended position (FIG. 6), the rear support or bow member 5 is spaced from the front support member 5 and from the front wall 8 of the pickup truck 2. In this position, the soft top 1 substantially covers the bed 4 of the pickup truck 2. Conversely, in the collapsed position of FIG. 3, the soft top 1, rear support member 5, and the overhead rack member 7 thereon are all positioned substantially adjacent the front support member 5 and front wall 8. The bed 4 of the pickup truck 2 is then open or exposed. Preferably, the seal member 55 engages the top of the tailgate 20 as shown but could engage other portions of the tailgate 20 (e.g., inside wall) if desired.

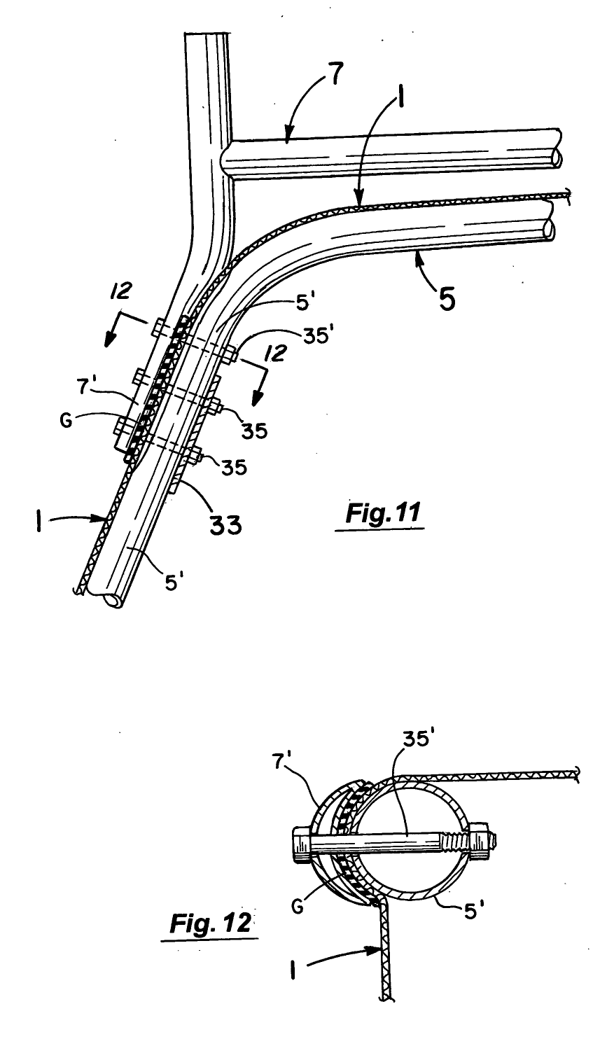

Whether or not the optional angle pieces 31 are used, areas of the soft top 1 of FIG. 9 are preferably pinched or clamped between the leg 7′ of each rack member 7 and the underlying leg 5′ of the support member 5. In the illustrated embodiment of FIGS. 11 and 12, this is accomplished using the three bolts 35, 35, and 35′. Fewer bolts can be used but in the illustrated version in which the optional angle pieces 31 are used, only the lower two bolts 35 as indicted above need be loosened to remove each angle piece 31. The upper bolt 35′ then maintains the soft top 1 at all times securely pinched or clamped between the legs 7′ and 5′ of the overhead rack member 7 and underlying support member 5 (FIG. 12) and does so independently of whether the angle pieces 31 are in place. In the illustrated embodiment of FIGS. 11 and 12, a flexible gasket G (e.g., rubber) is provided on the outside of the soft top 1 in the pinched or clamped area between the legs 51 and 7′. The gasket G helps to protect and strengthen the clamped area of the fabric of the soft top 1 and also aids in forming a seal where the bolts 35, 35′ pass through the fabric.

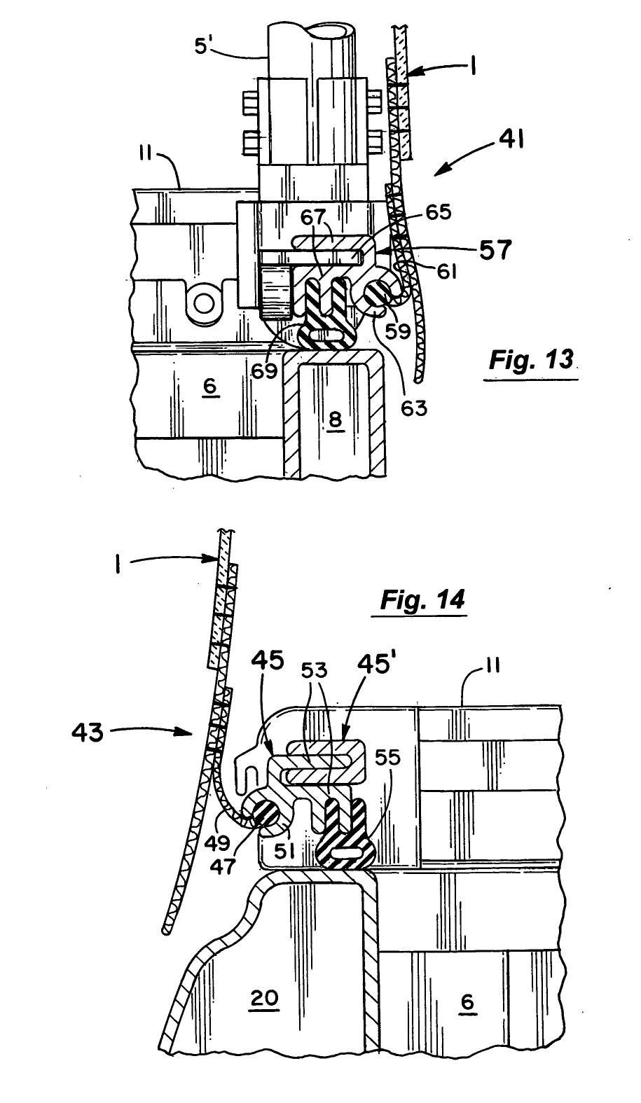

FIGS. 13 and 14 illustrate the arrangements by which the front and rear edge portions 41 and 43 of the soft top 1 are removably secured in place over the front wall 8 and the tailgate 20. Substantially in the manner of co-owned U.S. Pat. No. 6,286,888, the rear edge portion 43 of the soft top 1 (FIG. 14) includes a substantially rigid, elongated member 45 attached to the rear panel 48 or main body of the soft top 1. This can be done in any number of ways including the illustrated one with the dowel piece 47 on the flap 49 received in the C-shaped sleeve 51 in the elongated member 45. In operation, the U-shaped channel between the legs 53 of the member 45 in FIG. 14 is mated in the U-shaped clips 45′ on the rear of each rail 11 (see also FIG. 10). The elongated member 45 is then supported on the pickup side walls 6 rearwardly of the support member 5 to extend between the side walls 6 above the closed tailgate 20. A flexible and resilient seal member 55 is also provided on the elongated member 45 to engage the closed tailgate 20 as in FIG. 14. It is noted that the illustrated embodiment has three bow members 5. However, the middle bow member 5 could be removed if desired or if the bed 4 is relatively short. Similarly, a fourth or more bow members 5 could be added if the bed 4 is longer.

Like the rear edge portion 43 of the soft top 1, the front edge portion 41 in FIG. 13 is attached to an elongated member 57 (e.g., by the dowel 59 on the flap 61 received in the C-shaped sleeve 63). However, unlike the rear edge portion 43 and U.S. Pat. No. 6,286,888, the front edge portion 41 is removably secured to the legs 5′ of the front support or bow member 5. More specifically and as best seen in FIG. 9, a horizontally extending flange member 65 is attached to the bottom or free end of each leg 5′. Each flange member 65 then extends toward the other leg 5′ and is receivable between the legs 67 (FIG. 13) of the horizontally extending, U-shaped channel in the elongated member 57.

In this manner, the front edge portion 41 of the soft top 1 is supported to extend between the legs 5′ of the front support member 5 across the pickup truck 2. Additionally, the elongated member 57 of FIG. 13 is provided with a descending, flexible and resilient seal member 69 to sealingly engage the front wall 8 of the pickup truck 2. A weatherproof barrier is thereby created between the front edge portion 41 of the soft top 1 and the front wall 8. The securing structure for the front edge portion 41 is thus self-contained and easily and completely removed with the front support or bow member 5. This is particularly advantageous as no securing structure for the front edge portion 41 need be attached or added to the main body of the pickup truck 2 as all of the securing structure is part of the frame arrangement 3 for the soft top 1. Also, if the spacing between the front portion 41 of the soft top 1 and the cabin of the pickup truck is fairly tight as in FIG. 6, the sealing engagement of the member 69 and front wall 8 can be accomplished by simply sliding the front bow 5 forward to the position of FIG. 13 with the elongated member 57 already attached.

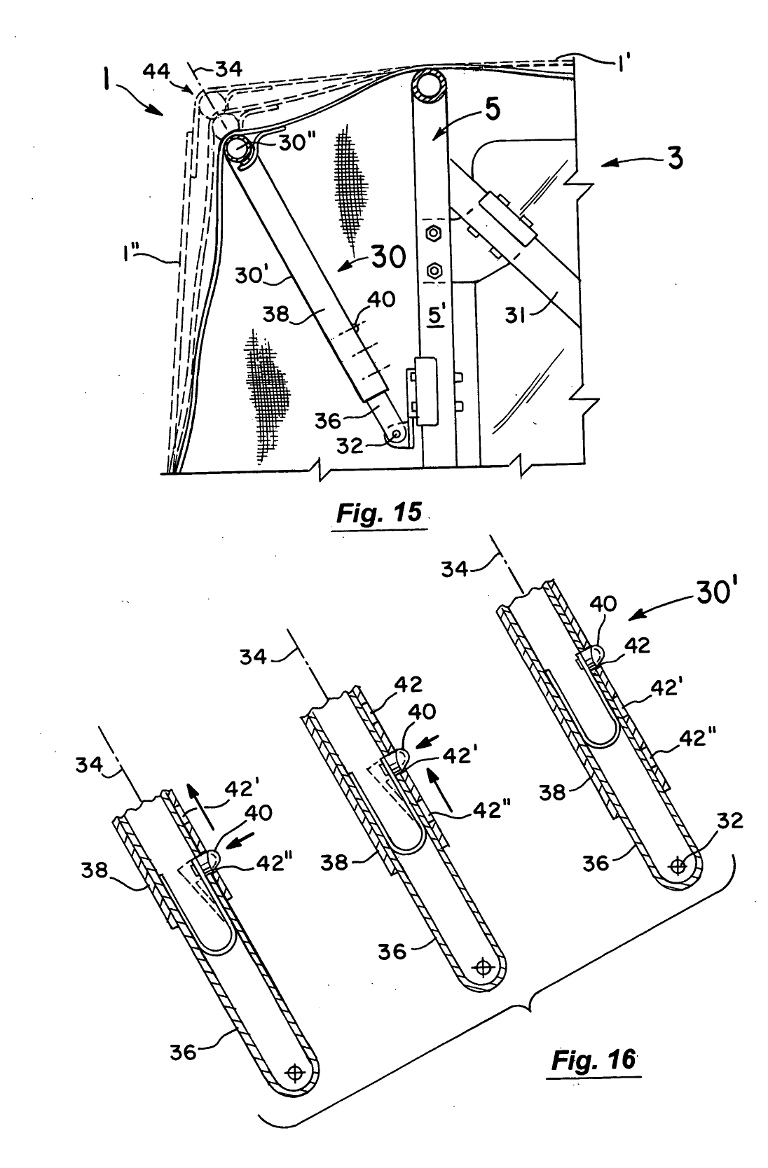

In FIGS. 15 and 16, a feature of the present invention is illustrated in which the tension in the soft top 1 can be adjusted. Such adjustment in the tension in the fabric of the flexible soft top 1 (e.g., vinyl, canvas) is often desirable to compensate for wear and temperature changes that can affect the fit of the soft top 1 on the frame arrangement 3. Temperature changes in particular may affect the tension in the soft top 1 several times even during the same day. In this regard, an additional or tension member 30 (see also FIGS. 4 and 6) is provided. The tension member 30 as illustrated in FIG. 4 has an inverted, substantially U-shape with spaced-apart legs 30′ and a base 30″ extending therebetween. The legs 30′ are respectively mounted to the legs 5′ of the rear support member 5 in FIGS. 4 and 15 for movement about the pivotal axis 32 (FIG. 15). The pivotal axis 32 is fixed relative to the rear support member 5 and each leg 30′ is selectively adjustable in length along its axis 34. In the illustrated embodiment of FIGS. 15 and 16, this adjustment of the legs 30′ to extend for different lengths along the respective axes 34 is accomplished by moving the telescoping sections 36 and 38 relative to each other. In the preferred embodiment, this adjustment is done in predetermined increments by first manually depressing the spring-biased detent 40 mounted in the inner section 36. The outer section 38 (FIG. 16) can then be axially moved to selectively align the detent 40 with the spaced-apart holes 42, 42′, and 42″ in the outer section 38.

In this manner, the length of each leg 30′ of the additional or tension member 30 along the axis 34 is selectively adjustable in predetermined increments. In doing so, the base 30″ on the tension member 30 in turn is selectively moved in predetermined increments relative to the rear support member 5 in FIG. 15. The result is that the tension in the soft top 1 between the secured front and rear portions 41 and 43 of FIGS. 6, 13, and 14 can be adjusted as needed or desired.

The legs 30′ as indicated above are preferably pivotally mounted at fixed locations along the legs 51 of the rear support member 5. Consequently, as the lengths of the legs 30′ of the tension member 30 are adjusted, the legs 30′ can also pivot as needed against the friction fit at 32 in response to any movement or tension changes in the soft top 1. As for example and in the illustrated embodiment of FIG. 15, the soft top 1 has a substantially horizontal roof section 1′ joined at the junction area 44 to a downwardly extending rear section 1″. The base 30″ of the tension member 30 can then be positioned substantially at the junction area 44 as shown and can move with the junction area 44 as the tension in the soft top 1 is adjusted. Although the operation of the tension member 30 is illustrated with the collapsible soft top 1 of the present invention, it can equally be used to tension any soft top that is secured at front and rear locations relative to the pickup truck 2 or other vehicle.

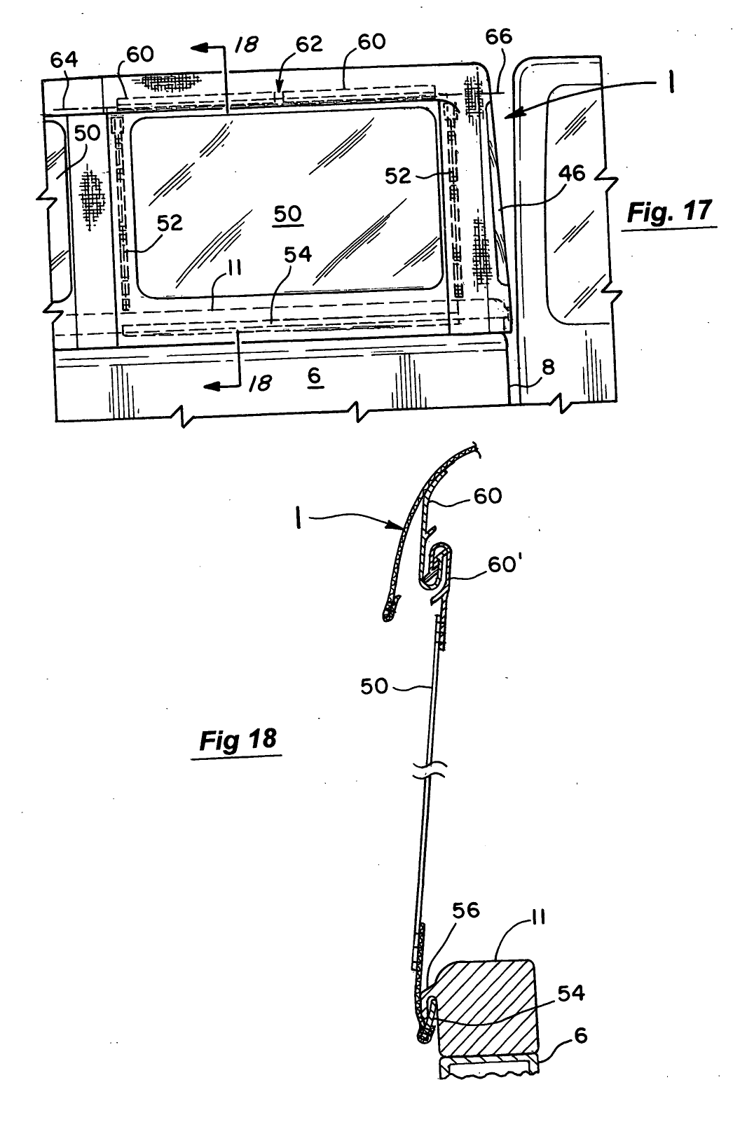

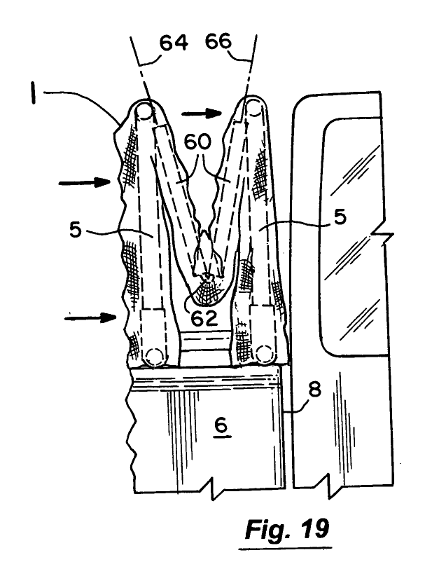

Referring to FIGS. 6 and 17, the soft top 1 of the present invention preferably includes front and rear window panels 46 and 48 which can be removable as can the side panels 50 (e.g., window, mesh, or solid fabric). The removal of the panels 50 in the side portion of the soft top 1 can be accomplished in a number of manners but in the illustrated embodiment of FIG. 17, the retainer arrangement for the upper edge portion of each side panel 50 has been specially designed to accommodate the folding or collapsing nature of the soft top 1. More specifically, each side panel 50 as shown in FIGS. 17 and 18 can have any number of known vertical attachments along their sides (e.g., snaps or the illustrated zippers 52 in FIG. 17). Similarly, the side panel 50 can have any number of known lower attachments (e.g., snaps or the illustrated belt 54 and groove 56 one of FIG. 18). This is the case because the vertical attachments along the sides essentially move with the collapsing support members 5 (FIG. 19) and the lower attachment on the panel 50 (e.g., belt 54) is removed with the panel 50. However, the upper attachment on the soft top 1 for the upper edge portion of the removed panel 50 must be able to fold and collapse with the soft top 1.

This upper attachment could be, for example, snaps or other arrangements that would fold with the soft top 1. However, the preferred upper attachment of the present invention includes the substantially rigid and elongated J-shaped retainers 60 of FIGS. 17 and 18 that are mounted (e.g., sewn) to the soft top 1. In use, the mating J-shaped retainer 60′ of the panel 50 (FIG. 18) can be axially aligned with and slid along the mating retainers 60 on the soft top 1 for a quick and easy attachment (versus for example snaps). Removal in turn is just as easy and quick. The interlocking retainers 60 and 60′ also form a substantially weatherproof seal (versus for example snaps).

Other advantages of the elongated J-shaped retainers 60 and 60′ include the lower cost of materials and manufacture (versus for example zippers). However, as indicated above, any such rigid retaining arrangement must be able to fold or collapse with the soft top 1. To accomplish this with the elongated, J-shaped retainers 60 of the present invention, at least two of them are provided which are slightly spaced from each other at the gap 62 in FIG. 17. The gap 62 in turn creates a hinge or pivotal area for the rigid retainers 60. In operation, the rigid retainers 60 can be aligned in the open position of FIG. 17. In this position, the respective axes 64 and 66 of the rigid retainers 60 are substantially collinear to receive the mating retainer 60′ of the panel 50. Thereafter, with the panel 50 removed, the retainers 60 can be moved to the partially folded or collapsed position of FIG. 19 and on to the fully folded or collapsed position of FIG. 3 in which the axes 64 and 66 of FIG. 19 would be substantially adjacent and substantially vertically parallel to each other. In the preferred embodiment, the collapsed retainers 60 can be subsequently folded inwardly and upwardly with the rest of the soft top 1. The folded retainers 60 and collapsed soft top 1 can then be held up by straps 68 or other means out of the way of the view of the driver through the window panel 46 of FIG. 3.

The above disclosure sets forth a number of embodiments of the present invention described in detail with respect to the accompanying drawings. Those skilled in this art will appreciate that various changes, modifications, other structural arrangements, and other embodiments could be practiced under the teachings of the present invention without departing from the scope of this invention as set forth in the following claims.

We claim:

1. An apparatus including a collapsible soft top (1) and frame arrangement (3) for a pickup truck (2), the pickup truck having a rear bed (4) with opposing, spaced-apart side walls (6) and a front wall (8) extending upwardly from the bed, the collapsible frame arrangement (3) including at least two support members (5) for the soft top and at least two overhead rack members (7) respectively mounted on the support members to extend above the soft top and substantially across the bed of the pickup truck between said side walls,
each support member (5) of said collapsible frame arrangement having an inverted, substantially U-shape with spaced-apart legs (5′) and a base (5″) extending therebetween, said soft top being positioned on said support members over the respective bases thereof to extend between the support members and substantially across the bed between said side walls,
a first of said support members having the legs (5′) thereof mounted on the respective side walls (6) to position the first support member adjacent the front wall (8) and a second of said support members having the legs (5′) thereof mounted on the respective side walls (6) for movement therealong between an extend position spacing the second support member from said first support member and from said front wall with the soft top substantially covering the bed of the pickup truck and a collapsed position with the soft top, second support member, and rack member mounted on the second support member substantially adjacent the first support member and front wall substantially uncovering the bed of the pickup truck.

2. The apparatus of claim 1 wherein the soft top includes front and rear edge portions (41,43), said front edge portion (41) being removably securable to said first support member to extend substantially across the first support member between the legs (5′) thereof and said rear edge portion (43) being spaced rearwardly of the legs of said second support member and being removably securable to said side walls (6) to extend substantially therebetween.

3. The apparatus of claim 2 wherein at least one of the legs of said first support member has a horizontally extending flange member (65) attached thereto and extending toward the other leg of the first support member, said front edge portion of said soft top including an elongated member (57) with a horizontally extending channel, said flange being receivable in said channel to secure the front edge portion (41) of the soft top to said first support member (5).

4. The apparatus of claim 2 wherein each leg of said first support member has a horizontally extending flange member attached thereto and extending toward the other leg of the first support member and said front edge portion of said soft top includes an elongated member with a horizontally extending channel, said flanges being respectively receivable in said channel to secure the front edge portion of the soft top to said first support member.

5. The apparatus of claim 1 wherein the soft top includes a front edge portion (41) secured to said first support member (5) to extend substantially across the first support member between the legs (5′) thereof, said front edge portion further including a seal member (69) to sealing engage said front wall (8).

6. The apparatus of claim 5 wherein said seal member is flexible and resilient.

7. The apparatus of claim 1 further including an additional support member (30) having an inverted, substantially U-shape with spaced-apart legs (30′) and a base (30″) extending therebetween, the legs (30′) of said additional support member being respectively mounted to the legs (5′) of the second support member (5) to position the base of the additional support member rearwardly of the base of the second support member, said soft top being positioned over the base of said additional support member.

8. The apparatus of claim 7 wherein the legs of the additional support member are pivotally mounted to the legs of the second support member for movement relative thereto about a pivotal axis (32).

9. The apparatus of claim 8 wherein said pivotal axis (32) is fixed relative to the second support member (5).

10. The apparatus of claim 7 wherein the legs of the additional support member extend along respective axes (34) and are selectively adjustable to extend for different lengths along the respective axes.

11. The apparatus of claim 10 wherein the legs of said additional support member are selectively adjustable in predetermined increments to extend for predetermined different lengths along the respective axes.

12. The apparatus of claim 10 wherein each leg of said additional support member is respectively mounted at a fixed location along the respective leg (5′) of said second support member wherein adjustments of the lengths of the legs (30′) of said additional support member move the base (30″) of said additional support member relative to said fixed locations.

13. The apparatus of claim 12 wherein adjustments of the lengths of the legs of said additional support member respectively move the base of the additional support member toward and away from said fixed locations.

14. The apparatus of claim 7 wherein said soft top has a rear edge portion (43) removably securable to said side walls (5) to extend substantially therebetween rearwardly of the legs of said second and additional support members with the soft top positioned over the bases of said second and additional support members, the legs (30′) of said additional support member extending along respective axes (34) and being selectively adjustable to extend for different lengths along the respective axes to selectively move the base (30″) of the additional support member relative to the second support member (5).

15. The apparatus of claim 14 wherein the base of said additional support member is selectively movable relative to said second support member about a pivotal axis (32) fixed relative to said second support member.

16. The apparatus of claim 14 wherein the legs of said additional support member extend along respective axes and the base of said additional support member is selectively movable relative to the second support member along said axes.

17. The apparatus of claim 14 wherein said soft top has a front portion (41) secured adjacent said front wall (8) and a rear portion (43) secured adjacent the second support member in said extended position with said soft top supported on the bases of said first, second, and additional support members between said secured front portion (41) and said secured rear portion (43) wherein said additional support member is movable relative to said second support member to selectively adjust tension in the soft top between said secured front portion and said secured rear portion.

18. The apparatus of claim 17 wherein said soft top has a substantially horizontal roof section (1′) joined at a junction area (44) to a rear section (1″) extending downwardly therefrom and the base (30″) of said additional support member is positionable substantially at the junction area of said roof and rear sections.

19. The apparatus of claim 18 wherein said rear section includes a removable window panel (48).

20. The apparatus of claim 1 wherein said rack members are mounted to the respective first and second support members with areas of the soft top clamped therebetween.

21. The apparatus of claim 1 further including at least one angle piece (31) extending between at least one of the side walls of the pickup truck and the leg (5′) of one of said support members substantially at an acute angle, said angle piece being releasably attached to said leg, and at least one of said rack members being mounted to said one support member with an area of the soft top clamped therebetween.

22. The apparatus of claim 1 wherein said soft top has side portions extending between respective legs of said first and second support members, at least one of said side portions having a removable panel (50) with a substantially horizontally extending upper edge portion, said one side portion having at least two, substantially rigid, elongated members (60) removably attachable to the upper edge portion of said panel, each elongated member extending along an axis and being mounted to said soft top for movement therewith relative to each other about a pivotal area (62) from a first, open position with the respective axes (64,66) of the elongated members (60) substantially collinear to a second, folded position with said axes substantially adjacent one another, said elongated members being in said first position when the second support member is in said extended position and being in said second position when said second support member is in said collapsed position.

23. The apparatus of claim 1 wherein at least one of the support members and the rack member mounted thereon extend substantially in a common vertical plane (V-V) across the bed of the pickup truck.

24. An apparatus including a soft top and frame arrangement for a pickup truck, the pickup truck having a rear bed with opposing, spaced-apart side walls and a front wall extending upwardly from the bed, the frame arrangement including at least two support members for the soft top,
each support member of said frame arrangement having an inverted, substantially U-shape with spaced-apart legs and a base extending therebetween, said soft top being positioned on said support members over the respective bases thereof to extend between the support members and substantially across the bed between said side walls,
a first of said support members having the legs thereof mounted on the respective side walls to position the first support member adjacent the front wall and a second of said support members having the legs thereof mounted on the respective side walls spaces from said first support member and from said front wall with the soft top substantially covering the bed of the pickup truck,
said soft top including front and rear edge portions, said front edge portion (41) being removably securable to said first support member (5) to extend substantially across the first support member between the legs (5′) thereof, at least one of the legs of said first support member having a horizontally extending flange member (65) attached thereto and extending toward the other leg of the first support member, said front edge portion of said soft top including an elongated member (57) with a horizontally extending channel, said flange being receivable in said channel to secure said front edge portion of said soft top to said first support member.

25. The apparatus of claim 24 wherein each leg of said first support member has a horizontally extending flange member attached thereto and extending toward the other leg of the first support member and said front edge portion of said soft top includes an elongated member with a horizontally extending channel, said flanges being respectively receivable in said channel to secure said front edge portion to said first support member.

26. The apparatus of claim 24 wherein said front edge portion (41) further includes a seal member (69) to sealing engage said front wall (8).

27. The apparatus of claim 26 wherein said seal member is flexible and resilient.

28. The apparatus of claim 24 wherein said rear edge portion (43) of said soft top is spaced rearwardly of the legs of said second support member and is removably securable to said side walls (6) to extend substantially therebetween.

29. An apparatus including a soft top and frame arrangement for a pickup truck, the pickup truck having a rear bed with opposing, spaced-apart side walls and a front wall extending upwardly from the bed, the frame arrangement including at least two support members for the soft top,
each support member of said frame arrangement having an inverted, substantially U-shape with spaced-apart legs and a base extending therebetween, said soft top being positioned on said support members over the respective bases thereof to extend between the support members and substantially across the bed between said side walls,
a first of said support members having the legs thereof mounted on the respective side walls to position the first support member adjacent the front wall and a second of said support members having the legs thereof mounted on the respective side walls spaces from said first support member and from said front wall with the soft top substantially covering the bed of the pickup truck,
said soft top including front and rear edge portions, said front edge portion (41) being removably securable to said first support member to extend substantially across the first support member between the legs (5′) thereof wherein said front edge portion further includes a seal member (69) to sealing engage said front wall (8).

30. The apparatus of claim 29 wherein said seal member is flexible and resilient.

31. An incrementally adjustable, tensioning arrangement for a soft top for a vehicle, said arrangement including a support member (5) and a tension member (30), each of said members having an inverted, substantially U-shape with spaced-apart legs and a base extending therebetween, said soft top having front and rear portions respectively secured at front and rear locations relative to said vehicle, the legs (5′) of said support member (5) being mounted on said vehicle and the legs (301) of said tension member (30) being respectively mounted to the legs (51) of the support member, said soft top being positioned between said secured front and rear portions (41,43) over the respective bases of said support member and said tension member, the legs (30′) of said tension member extending along respective axes (34) and being selectively adjustable in predetermined increments to extend for predetermined different lengths along the respective axes to selectively move the base (30″) of the tension member (30) relative to the support member (5) and incrementally adjust the tension in the soft top between the secured front and rear portions.

32. The arrangement of claim 31 wherein the legs (30′) of the tension member are pivotally mounted to the legs (5′) of the second support member for movement relative thereto about a pivotal axis (32).

33. The arrangement of claim 32 wherein said pivotal axis is fixed relative to the support member.

34. The arrangement of claim 31 wherein said soft top has a substantially horizontal roof section (1′) joined at a junction area (44) to a rear section (1″) extending downwardly therefrom and the base (30″) of said tension member is positionable substantially at the junction area of said roof and rear sections.
